(19) United States
(12) Patent Application Publication
(10) Pub. No.: US 2006/0196724 A1
(43) Pub. Date: Sep. 7, 2006

(54) LADDER BRACKET

(76) Inventor: Louie Suterski, Burlington (CA)

Correspondence Address: MARK A KOCH, 866 MAIN STREET EAST, HAMILTON, ON, L8M1L9, CA

(21) Appl. No.: 11/164,930

(22) Filed: Dec. 12, 2005

Related U.S. Application Data
(60) Provisional application No. 60/635,016, filed on Dec. 13, 2004.

(51) Int. Cl. E06C 7/16

(52) U.S. Cl. 182/117; 182/129

(57) ABSTRACT

The present invention is a ladder bracket for use with a ladder, the ladder bracket comprising a top frame rigidly connected and spaced from a bottom frame; the top frame including means including a first top arm oriented along a longitudinal direction spaced from and parallel to a second top arm oriented along the longitudinal direction wherein the top arms rigidly connected together with upper transverse braces. The top frame defines a horizontal support plane when the ladder bracket attached to the ladder which is in a inclined position against a wall. Each top arm including forward hooks rigidly attached at a forward distal end of each top arm for realeasably attaching to the rungs of the ladder, such that the ladder bracket adapted to be mounted in an outside mounted position when said forward hooks are releasably attached to the rungs of the ladder. Each top arm also including rear hooks rigidly attached at a rear distal end of each top arm for realeasably attaching to the rungs of the ladder, such that the ladder bracket adapted to be mounted in a inside mounted position when said rear hooks are releasably attached to the rungs of the ladder.

This application claims priority from previously filed U.S. Provisional Application 60/635,016 filed on Dec. 13, 2004.

### FIELD OF THE INVENTION

The present invention relates to ladder scaffolding and particularly relates to a ladder bracket which can be used to create scaffolding between ladders.

### BACKGROUND OF THE INVENTION

There are many different types of scaffolds as well as methods of erecting scaffolding that have been used in the past. Most of these scaffolding techniques are comprised of sectional elements which are attached together to create a scaffolding structure which is normally supported by the surrounding of horizontal ground and often braced onto the vertical wall as the scaffolding gets higher and higher. This more permanent scaffolding is traditional scaffolding used on heavy construction sites, where the scaffolding heights can exceed three or four stories high. For residential construction projects, the requirement for scaffolding is usually no more than two stories in height and often scaffolding is used for laying bricks and/or applying siding to a home. For residential construction applications an apparatus which can be more easily set up and taken down have been proposed, such as the ladder scaffold bracket shown in U.S. Pat. No. 800,896 by Benedict Biehler, titled Ladder Scaffold Bracket, which describes a type of bracket arrangement which is slidably attached to a ladder and which can be raised and lowered by a rope and pulley mechanism attached to the ladder and the bracket.

A variation of this type of arrangement is shown in U.S. Pat. No. 5,601,154 issued Feb. 11, 1997 to Gary Eisenmenger, titled Portable Suspended Roof Scaffold System, describes a scaffolding system which can be attached to the ladder, wherein the bracket attachment to the ladder can be moved up and down the ladder again using the rope and pulley technique which is standard for ladders. This particular apparatus is more particularly suited for use on roof tops rather than on vertical walls.

Finally, U.S. Pat. No. 4,972,922 issued Nov. 27, 1990 to Bernard J. Levine, titled Adjustable Scaffolding Assembly, describes again a ladder having a bracket attachment which can be slidably moved along the ladder using a rope and pulley system and again is shown to be used more suitably for roof top applications, rather than for vertical walls.

The above three mentioned ladder attachment systems, all have in common that they are slidably mounted onto a ladder for movement up and down along the ladder using a rope and pulley system. Secondly, they are not easily attached or detached from the ladder and therefore once they have been mounted onto the ladder, they are more or less a permanently affixed thereto and that they are very difficult to remove from the ladder and thirdly, none of the above described apparatus makes it easy for one to be able to move the bracket assembly from the inside face of the ladder to the outside face of the ladder depending upon where the work is being carried out.

### SUMMARY OF THE INVENTION

The present invention is a ladder bracket for use with a ladder, the ladder bracket comprising a top frame rigidly connected and spaced from a bottom frame; the top frame including means for releasably attaching the ladder bracket to the rungs of a ladder, wherein the top frame defines a horizontal support plane when the ladder bracket attached to the ladder which is in a inclined position against a wall.

Preferably wherein the top frame including a first top arm oriented along a longitudinal direction spaced from and parallel to a second top arm oriented along the longitudinal direction wherein the top arms rigidly connected together with upper transverse braces.

Preferably wherein the attaching means including forward hooks rigidly attached at a forward distal end of each top arm for realeasably attaching to the rungs of the ladder, such that the ladder bracket adapted to be mounted in an outside mounted position when said forward hooks are releasably attached to the rungs of the ladder.

Preferably wherein the attaching means including rear hooks rigidly attached at a rear distal end of each top arm for realeasably attaching to the rungs of the ladder, such that the ladder bracket adapted to be mounted in a inside mounted position when said rear hooks are releasably attached to the rungs of the ladder.

Preferably wherein the bottom frame including a forward cross bar oriented along a transverse direction for abutting against C channels of the ladder when the ladder bracket mounted in the outside mounted position.

Preferably wherein the bottom frame including a rear cross bar oriented along a transverse direction for abutting against C channels of the ladder when the ladder bracket mounted in the inside mounted position.

Preferably wherein the top frame being parallel to and spaced from the bottom frame and wherein forward connecting members and rear connecting members rigidly joining the top frame to the bottom frame.

Preferably wherein the connecting members oriented at an angle beta relative to vertical such that the connecting members being substantially parallel with C channels of the ladder thereby orienting the top frame substantially horizontally when the ladder bracket is mounted onto the ladder which is an inclined position against a wall.

Preferably wherein the angle beta is substantially equal to an angle alpha which is the angle the ladder makes relative vertical when the ladder is in an inclined position against a wall.

Preferably wherein at least one top arm including a pair of spaced apart stops rigidly connected to the top arm, wherein the stops dimensioned and adapted to receive a plank there between such that the plank is supported by the top frame in the horizontal support plane.

The present invention can also be a combination of a plurality of ladder brackets and a ladder assembly comprising:
(a) At least two ladders spaced apart and mounted in an inclined position against a wall;
(b) At least one ladder bracket mounted in an inside mounted position on each ladder;
(c) At least one plank mounted so as to span horizontally between the ladder brackets and supported by the top frame positioned in the horizontal support plane of each ladder bracket, such that the plank spanning between the ladders providing a horizontal support surface.

The present invention can also be a combination of a plurality of ladder brackets and a ladder assembly comprising:
(a) At least two ladders spaced apart and mounted in an inclined position against a wall;
(b) At least one ladder bracket mounted in an outside mounted position on each ladder;
(c) At least one plank mounted so as to span horizontally between the ladder brackets and supported by the top frame positioned in the horizontal support plane of each ladder bracket, such that the plank spanning between the ladders providing a horizontal support surface.

### BRIEF DESCRIPTION OF THE DRAWINGS

The present invention, a ladder bracket will now be described by way of example only with reference to the following drawings in which:

FIG. 1 is a bottom plan view of the present invention a ladder bracket.

FIG. 2 is a top plan view of the present invention a ladder bracket.

FIG. 3 is an end plan view of the present invention a ladder bracket.

FIG. 4 is a side plan view of the present invention a ladder bracket.

FIG. 5 is a bottom perspective view of the present invention a ladder bracket.

FIG. 6 is a bottom perspective view of the present invention a ladder bracket.

FIG. 7 is a top perspective view of the present invention a ladder bracket.

FIG. 8 is a top perspective view of the present invention a ladder bracket.

FIG. 9 is the present invention a ladder bracket shown together mounted onto a ladder placed against the vertical wall.

FIG. 10 is a perspective view of the present invention two ladder brackets shown mounted onto ladder together with planking against a vertical wall showing typical use of the ladder bracket together with ladders and planks.

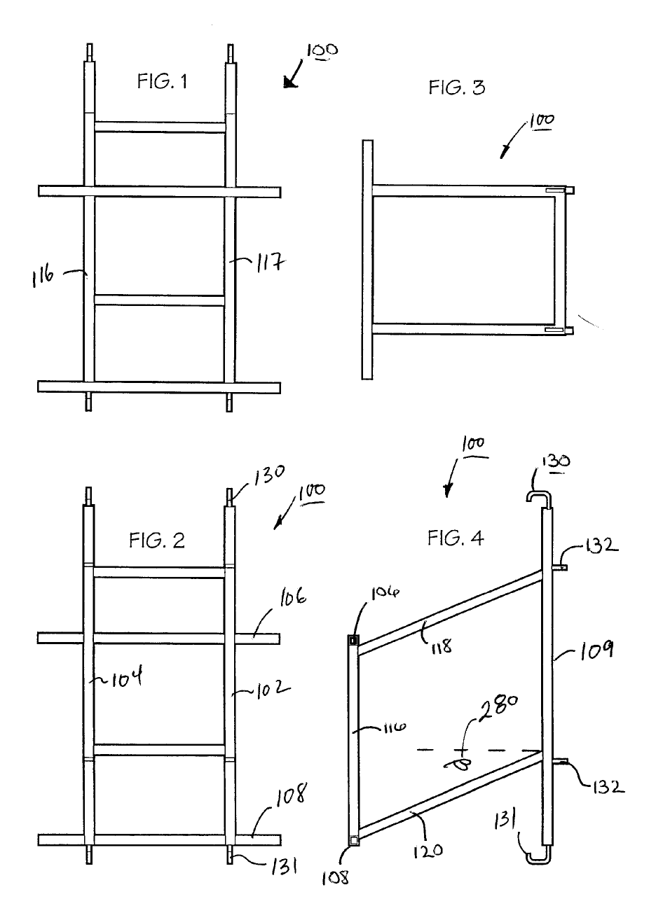

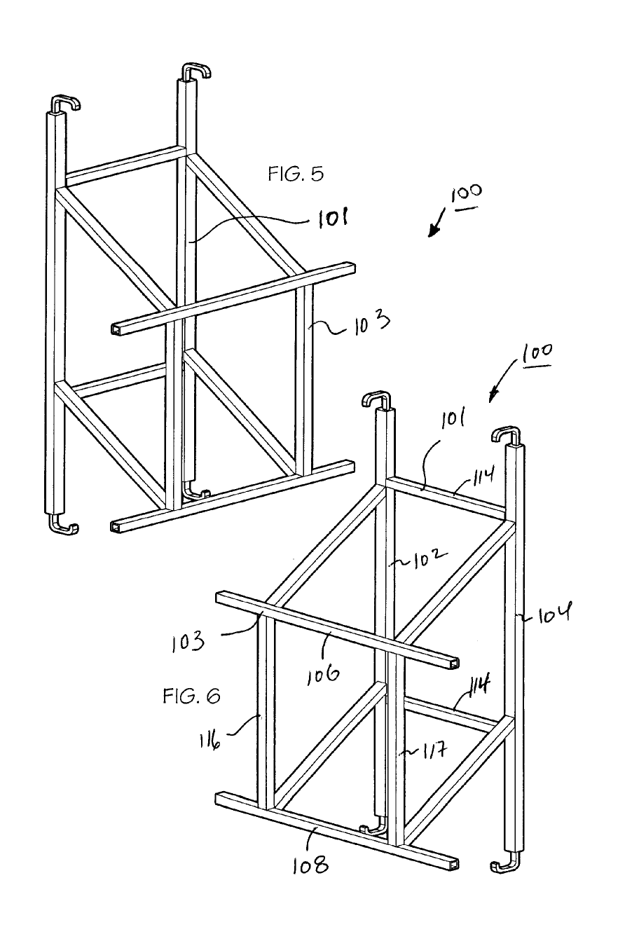

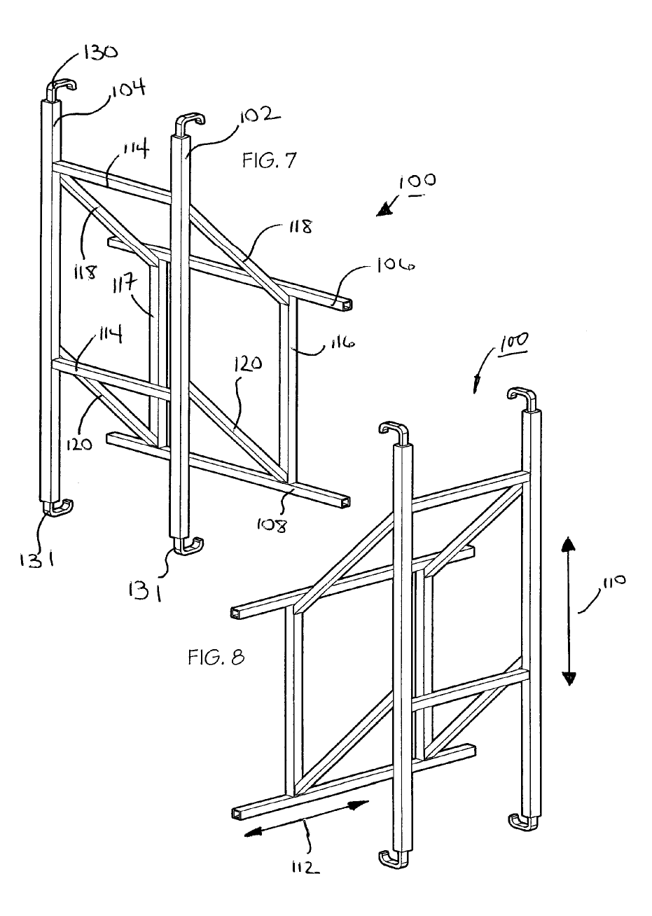

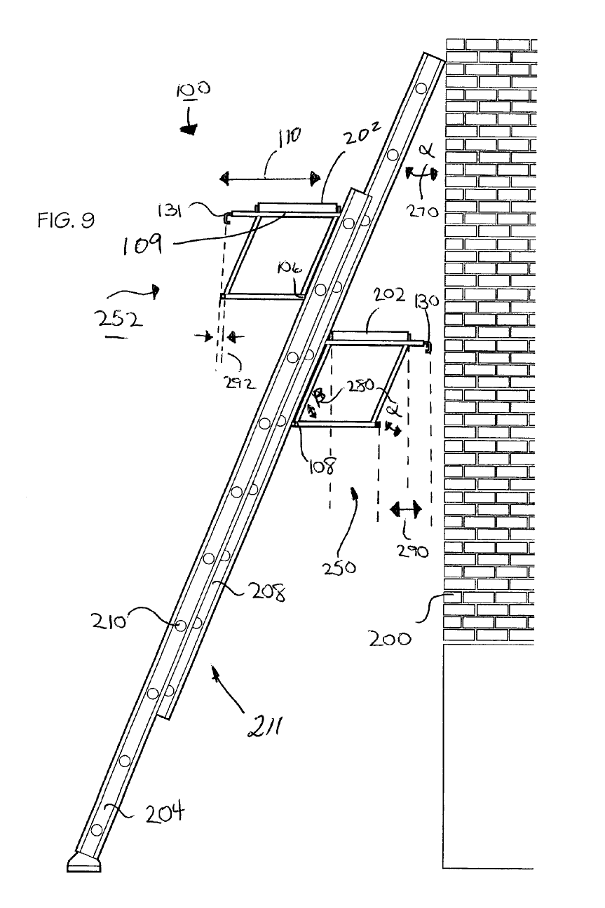

### DETAILED DESCRIPTION OF THE PREFERRED EMBODIMENT

The present invention a ladder bracket shown generally as 100 includes a rigid frame adapted to releasably connect to the rungs of a ladder. Ladder bracket 100 includes the following major components namely, top frame 101 connected to bottom frame 103 with forward and rear connecting members 118 and 120. Top frame 101 defines a horizontal support plane 109 which is adapted to support a plank 202 thereon. Top frame 101 includes first top arm 102 oriented along the longitudinal direction 110, and second top arm 104 also oriented along the longitudinal direction 110, two upper transverse braces 114 for connecting together first top arm 102 and second top arm 104. On each distal end of top arm 102 and 104 are forward hooks 130 and rear hooks 131 respectively. Optionally as shown in FIG. 4 mounted on the top of first top arm 102 and second top arm 104 are stops 132 which are spaced apart in order to accommodate a board there between which is spanned across two ladder brackets. As shown in FIG. 10 the ladder brackets are spaced apart, each ladder bracket 100 hung on an individual ladder and a plank 202 is spanned across ladder brackets 100.

Bottom frame 103 includes first longitudinal brace 116 oriented along the longitudinal direction 110, and second longitudinal brace 117 also oriented along the longitudinal direction 110, forward cross bar 106 oriented along the transverse direction 112 and rear cross bar 108, also oriented along the transverse direction 112. Top frame 101 and bottom frame 103 are connected with forward connecting members 118 and rear connecting members 120.

In Use

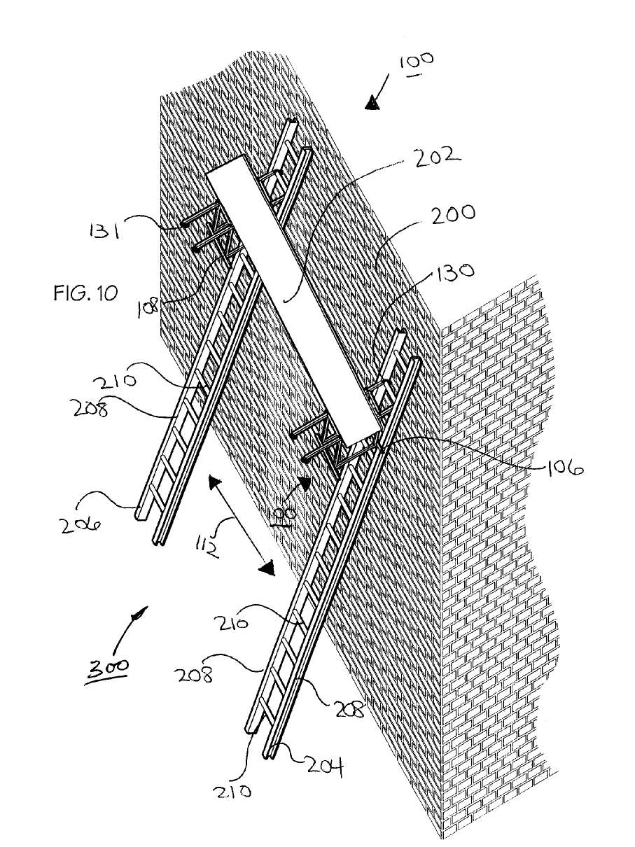

Referring now to FIGS. 9 and 10 in particular, FIG. 9 shows a ladder bracket 100 hung in an outside mounted position 252 on ladder 204 which is shown in place in an inclined position 211. Forward hooks 130 are latched onto rungs 210 of ladder 204 and forward cross bar 106 makes contact by abutting against C-channels 208 of ladder 204, thereby bracing ladder bracket 100 against ladder 204.

In the inclined position 211 the angle that ladder 204 makes with wall 200 is shown as angle alpha 270 and it is recommended in most jurisdictions that for every four feet that the ladder is raised vertically along wall 200, that the bottom of ladder 204 be placed at least one foot out from the wall. Therefore, the angle alpha 270 would be roughly 14 degrees. Some contractors and/or jurisdictions require that for every four feet the ladder is moved vertically upward along walls 200, that the feet of the ladder be spaced two feet away from wall 200 in which case the angle alpha 270 made is approximately 26 degrees.

A person skilled in the art will note that forward connecting members 118 as well as rear connecting members 120 make an angle beta shown as 280 with respect to a vertical line reference and this angle beta 280 preferably is the same or very close to the angle alpha 270 that the ladder makes with the vertical wall 200. By maintaining the same angle alpha 270, that the ladder makes with the wall and beta 280 that the forward connecting members 118 and the rear connecting members 120 make with a vertical line, one is able to keep first top arm 102 and second top arm 104 parallel or level with the ground.

As a result of respecting these angles, there is a natural distance D shown as 290 made between the forward hooks 130 and the forward cross bar 106 and a distance E shown as 292 which is the distance between rear hooks 131 and rear cross bar 108 as shown in FIG. 9.

Furthermore, FIG. 9 indicates that ladder bracket 100 can be placed in the outside mounted position 252 in which case one can work from the outside of ladder 204 to gain access to large over hangs and other items situated directly above or adjacent to ladder bracket 100.

In some circumstances, when using ladder bracket 100, it is preferable to mount ladder bracket 100 in an inside mounted position 250 as shown in FIG. 9 in which case, the rear hooks 131 engage with a rung 210 of ladder 204 and rear cross bar 108 makes contact with the C-channels 208 of ladder 204. In inside mounted position 250, one can place a plank 202 onto the top of first top arm 102 and second top arm 104 and this plank is held between stops 132 which are rigidly connected to first top arm 102 and second top arm 104 preventing plank 202 from sliding off of ladder bracket 100.

By positioning ladder bracket 100 in inside mounted position 250, one can gain closer access to wall 200 for example, in situations when one is applying siding and/or stucco to a wall face.

Rear connecting members 120 make an angle beta 280 which is very close to an angle alpha 270 made by ladder 204 positioned against wall 200. In this manner, one can ensure that the top arms 102 and 104 remain horizontal to the ground and that planks 202 remain securely positioned on ladder brackets 100.

Referring now to FIG. 10 which shows two ladder brackets 100 mounted in the outside mounted position 252, on two ladders, namely first ladder 204 and second ladder 206, each of which are positioned against a wall 200. Plank 202 is placed to span between ladders 204 and 206 and is placed on the horizontal plane 109 which is on top arms 102 and 104 in between stops 132 of each of the ladder brackets 100. This combination is called a ladder assembly 300 and is depicted in FIG. 10. The plank 200 thereby provides a horizontal support surface for walking thereon for example. Traditionally, for example when a contractor is installing siding and/or stucco onto a wall, he may in fact place numerous ladders side by side up against wall 200 as many as six, eight or ten ladders and the installer would simply straddle from one ladder to the next as he works across wall 200. By using ladder assembly 300, one can see that the installer simply needs to place two ladders spaced apart from each other against wall 200 and forward hooks 130 into a rung 210 of each ladder and place a plank 202 which spans between the two ladder brackets 100. In this manner the installer can scale one of the ladders and climb on top of plank 102 and walk across plank 102 as he is installing his materials across the face of wall 200.

In similar fashion, although not shown, one can install ladder assembly 300 such that ladder brackets 100 are in the inside mounted position 250 in which case plank 202 would be situated beneath the ladders 204 and 206, rather than on top of the ladders 204 and 206 as shown in FIG. 10 and by placing the ladder brackets in the inside mounted position 250, the installer can gain closer access to the face of wall 200. In this case, rather than forward hooks being hooked into rungs 210 and the forward cross bar 106, resting against the C-channels, 208 of the ladder 204 and 206, in the inside mounted position, the rear hooks 131 are hooked into a rung 210 of each of the ladders 204 and 206 and the rear cross bar 108 makes contact with the inside of C-channel 208.

It should be apparent to persons skilled in the arts that various modifications and adaptation of this structure described above are possible without departure from the spirit of the invention the scope of which defined in the appended claim.

What is claimed is:

1. A ladder bracket for use with a ladder, the ladder bracket comprising a top frame rigidly connected and spaced from a bottom frame; the top frame including means for releasably attaching the ladder bracket to the rungs of a ladder, wherein the top frame defines a horizontal support plane when the ladder bracket attached to the ladder which is in a inclined position against a wall.

2. The ladder bracket claimed in claim 1, wherein the top frame including a first top arm oriented along a longitudinal direction spaced from and parallel to a second top arm oriented along the longitudinal direction wherein the top arms rigidly connected together with upper transverse braces.

3. The ladder bracket claimed in claim 2 wherein the attaching means including forward hooks rigidly attached at a forward distal end of each top arm for realeasably attaching to the rungs of the ladder, such that the ladder bracket adapted to be mounted in an outside mounted position when said forward hooks are releasably attached to the rungs of the ladder.

4. The ladder bracket claimed in claim 3 wherein the attaching means including rear hooks rigidly attached at a rear distal end of each top arm for realeasably attaching to the rungs of the ladder, such that the ladder bracket adapted to be mounted in a inside mounted position when said rear hooks are releasably attached to the rungs of the ladder.

5. The ladder bracket claimed in claim 4 wherein the bottom frame including a forward cross bar oriented along a transverse direction for abutting against C channels of the ladder when the ladder bracket mounted in the outside mounted position.

6. The ladder bracket claimed in claim 5, wherein the bottom frame including a rear cross bar oriented along a transverse direction for abutting against C channels of the ladder when the ladder bracket mounted in the inside mounted position.

7. The ladder bracket claimed in claim 1, wherein the top frame being parallel to and spaced from the bottom frame and wherein forward connecting members and rear connecting members rigidly joining the top frame to the bottom frame.

8. The ladder bracket claimed in claim 7 wherein the connecting members oriented at an angle beta relative to vertical such that the connecting members being substantially parallel with C channels of the ladder thereby orienting the top frame substantially horizontally when the ladder bracket is mounted onto the ladder which is an inclined position against a wall.

9. The ladder bracket claimed in claim 8 wherein the angle beta is substantially equal to an angle alpha which is the angle the ladder makes relative vertical when the ladder is in an inclined position against a wall.

10. The ladder bracket claimed in claim 2, wherein at least one top arm including a pair of spaced apart stops rigidly connected to the top arm, wherein the stops dimensioned and adapted to receive a plank there between such that the plank being supported by the top frame in the horizontal support plane.

11. In combination a plurality of ladder brackets as claimed in claim 6, 9, or 10 and a ladder assembly comprising:
(a) At least two ladders spaced apart and mounted in an inclined position against a wall;
(b) At least one ladder bracket mounted in an inside mounted position on each ladder;
(c) at least one plank mounted so as to span horizontally between the ladder brackets and supported by the top frame positioned in the horizontal support plane of each ladder bracket, such that the plank spanning between the ladders providing a horizontal support surface.

12. In combination a plurality of ladder brackets as claimed in claim 6, 9, or 10 and a ladder assembly comprising:
(a) At least two ladders spaced apart and mounted in an inclined position against a wall;
(b) At least one ladder bracket mounted in an outside mounted position on each ladder;
(c) at least one plank mounted so as to span horizontally between the ladder brackets and supported by the top frame positioned in the horizontal support plane of each ladder bracket, such that the plank spanning between the ladders providing a horizontal support surface.
